(19) United States
(12) Patent Application Publication
(10) Pub. No.: US 2013/0113198 A1
(43) Pub. Date: May 9, 2013

(54) MEDIA SOCK, SYSTEM AND METHOD OF USE

(71) Applicant: John Boothby, Coogee (AU)

(72) Inventor: John Boothby, Coogee (AU)

(73) Assignee: Market Avenues Pty Ltd., Redfern, New South Wales (AU)

(21) Appl. No.: 13/502,830

(22) PCT Filed: Jul. 1, 2011
(86) PCT No.: PCT/AU11/00833

§ 371 Date: Dec. 19, 2012

(30) Foreign Application Priority Data
Jul. 2, 2010 (AU) 2010902943
Mar. 17, 2011 (AU) 2011100300

(51) Int. Cl. B42D 15/00

(52) U.S. Cl. CPC B42D 15/00
USPC 283/56

(57) ABSTRACT

A media sock including at least one display surface carrying indicia to be displayed and a mounting assembly to mount the media sock relative to a mounting portion, wherein the at least one display surface is at least partially transparent to the non-visible portion of the electromagnetic spectrum but visually opaque.

### FIELD OF THE INVENTION

The present invention relates to the advertising field in general and particularly to apparatus used for advertising display purposes.

### BACKGROUND ART

Currently, shopping chains use their security gates to advertise their wares or use them for branding purposes. In most cases this is done by printing and then fabricating a cardboard or extruded core flute cover which is slid over the security gate from above. It allows the radio signals to pass through and gives good media exposure at the point of store entrance.

There are however multiple problems with the above system. The finished unit must be optically pleasing i.e. no folds or creases, and the image substrate must be reasonably securely fastened around the gate frame so it cannot be dislodged easily. The fit of the cardboard or extruded core flute cover is generally loose as in most cases it needs to rest on the floor. It is easily damaged by passers through and creases and marks stay on the units in full view. Therefore, the lifespan of the advertising cover is greatly reduced.

Other problems include shipping and logistics to get the large sheets to the various stores without damaging them and finally having untrained store staff fit them into place. In a media application, the change of the image must occur in the cheapest way and shortest possible time.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a media sock, system and method of use, which may at least partially overcome at least one of the abovementioned disadvantages or provide the consumer with a useful or commercial choice.

With the foregoing in view, the present invention in one form, resides broadly in a media sock including at least one display surface carrying indicia to be displayed and a mounting means to mount the media sock relative to a mounting assembly, wherein the at least one display surface is at least partially transparent to the non-visible portion of the electromagnetic spectrum but visually opaque.

In an alternative embodiment, the invention resides in a media sock display system including a mounting assembly including a projection defining a shape for display and at least one media sock including at least one display surface carrying indicia to be displayed and a mounting means to mount the media sock relative to the mounting assembly, wherein the at least one display surface is at least partially transparent to the non-visible portion of the electromagnetic spectrum but visually opaque.

In a further alternative embodiment, the invention resides in a method of displaying media including the steps of providing a mounting assembly including a projection defining a shape for display, providing a media sock including at least one display surface carrying indicia to be displayed wherein the at least one display surface is at least partially transparent to the non-visible portion of the electromagnetic spectrum but visually opaque and a mounting means to mount the media sock relative to the mounting assembly and mounting the media sock relative to the mounting assembly.

The present invention offers an addition point of advertising by printing advertising onto the media sock which can then be positioned over the electronic article surveillance security gate from above. The media sock allows the electromagnetic (EM) signals to pass through and gives good media exposure at the point of store entrance.

The present invention includes a media sock having at least one display surface carrying indicia to be displayed.

The media sock is typically a full sock having a pair of display surfaces and closed at the upper and side edges with an open bottom.

In an alternative embodiment, the media sock may be a part sock having a single display surface and a pair of loops as one example of a mounting assembly which allows the media sock it to be mounted relative to a mounting portion but is not a full sock.

The media sock, particularly when provided as a full sock, is preferably at least partially resilient although, the media sock may be substantially inelastic and simply provided with one or more resilient portions to secure the media sock.

Typically, the media sock and the display surfaces are fabric but may be manufactured from any material. When manufactured from fabric, a knitted fabric is preferred.

The indicia to be displayed may include one or more colours only, but will normally include printing or other advertising material designed to convey a particular message. Any form of application of the indicia onto or into the material of the display surface may be used. Sublimation printing onto a fabric display surface is particularly preferred. The display surface may be a part of the sock, indeed may be the sock itself, but may be another surface attached to or relative to the sock in preferred forms.

Indicia to be displayed may be provided on a pair of display surfaces and/or along one or more of the edges of the media sock.

Typically, a full sock is formed from one or more pieces of fabric which are attached together along the top and side edges to define a shaped sock which corresponds to the shape of the mounting assembly.

A full sock may be provided with means for securing the sock relative to the mounting portion. In a simple form, this may include gathering at the lower end of the sock adjacent to the open bottom or alternatively, resilient or elastic means provided adjacent the open bottom.

In a further alternative embodiment, an elongate flexible member may be provided in a circumferential tubular portion adjacent the open bottom and may be used to draw the open bottom of the sock into a smaller configuration to prevent accidental removal of the sock from the mounting portion.

It is to be remembered that the ease of mounting of the sock relative to the mounting portion is important and should be configured so as to minimise accidental removal but allow relatively easy determined removal.

The media sock is preferably shaped and typically is shaped to correspond with mounting assembly or part thereof. The media sock is also sized to be taut when mounted on the mounting assembly in order to prevent creasing and the like which may obscure the indicia. Typically, the sock must be expanded or deformed to an enlarged size approximately the size and shape of the mounting assembly during mounting the media sock.

The present invention includes a mounting means in order to mount the media sock relative to a mounting assembly. The mounting means may take any form and in its simplest form, the mounting means is at least part of the sock itself, particularly with reference to a full sock which at least partially receives the mounting assembly within.

The preferred resilient nature of at least a part of the full sock then retains the full sock relative to the mounting assembly.

A lower resilient portion may be provided in addition to or instead of providing a resilient sock. In this embodiment, a lower periphery of the sock may be size adjustable and slightly resilient to hold the media sock relative to the mounting portion.

More complex mounting means may be provided in different configurations. For example, in the part sock configuration discussed briefly above, a single display surface may be provided with a pair of loops extending therefrom and which are adapted to receive the mounting assembly to locate the display surface relative to a side of the mounting assembly.

Any mounting assembly may be used.

The mounting assembly is typically a transmitter and/or receiver. These are normally generally rectangular, upstanding objects which are located on either side of a doorway. They typically include an enlarged foot with an upstanding, generally rectangular frame. Whilst the particular form of transmitter and/or receiver may differ slightly between different security systems (which include RFID, electromagnetic and new acousto-magnetic systems), the mounting portion is generally similar in overall shape from all three systems.

The transmitter and/or receiver normally has one or more lights at the top of the frame. Preferably, the media sock of the present invention will typically leave the lights clear. For example, the media sock may be provided with an opening at an upper end sized and located to allow the lights to protrude through the media sock but maintaining a shoulder portion in order to prevent the media sock slipping downward over the transmitter and/or receiver.

The media sock of the present invention will typically cover the frame of the transmitter and/or receiver and extend downwardly to adjacent the foot. Preferably, the attachment mechanism (normally an elasticised periphery of the lower opening) will normally be located adjacent or even abutting the foot. In this way, the transmitter and/or receiver will be covered and advertising can be displayed on the media sock.

In an alternative embodiment, the mounting assembly may include a mounting frame, preferably a freestanding mounting frame. The mounting frame preferably includes a foot adapted to abut or be mounted to a surface with a frame extending therefrom. This will allow the media sock of the present invention to be used as a display in any location, fixed or mobile, and still allow easy replacement of the media sock to change the message conveyed by the indicia, quickly and easily, and by unskilled labour.

Any of the features described herein can be combined in any combination with any one or more of the other features described herein within the scope of the invention.

### BRIEF DESCRIPTION OF THE DRAWINGS

Various embodiments of the invention will be described with reference to the following drawings, in which:

FIG. 1 is an axonometric view of a common security gate in a frame embodiment.

FIG. 2 is a fabric media sock according to a preferred embodiment of the present invention.

FIG. 3 is an axonometric view of the security gate of FIG. 1 with the media sock of FIG. 2 stretched over the frame.

FIG. 4 is an axonometric view of an alternative common security gate in a frame embodiment with a light atop the frame.

FIG. 5 is a fabric media sock according to a preferred embodiment of the present invention adapted to be used with the security gate illustrated in FIG. 4.

### DETAILED DESCRIPTION OF THE PREFERRED EMBODIMENT

According to a particularly preferred embodiment of the present invention, a media sock 10, media display system and method of use is provided.

The media sock 10 illustrated in the Figures includes a pair of display surfaces 11, a face surface and an obverse surface, at least one of which carries indicia to be displayed. Each display surface 11 is at least partially transparent to the non-visible portion of the electromagnetic spectrum but visually opaque.

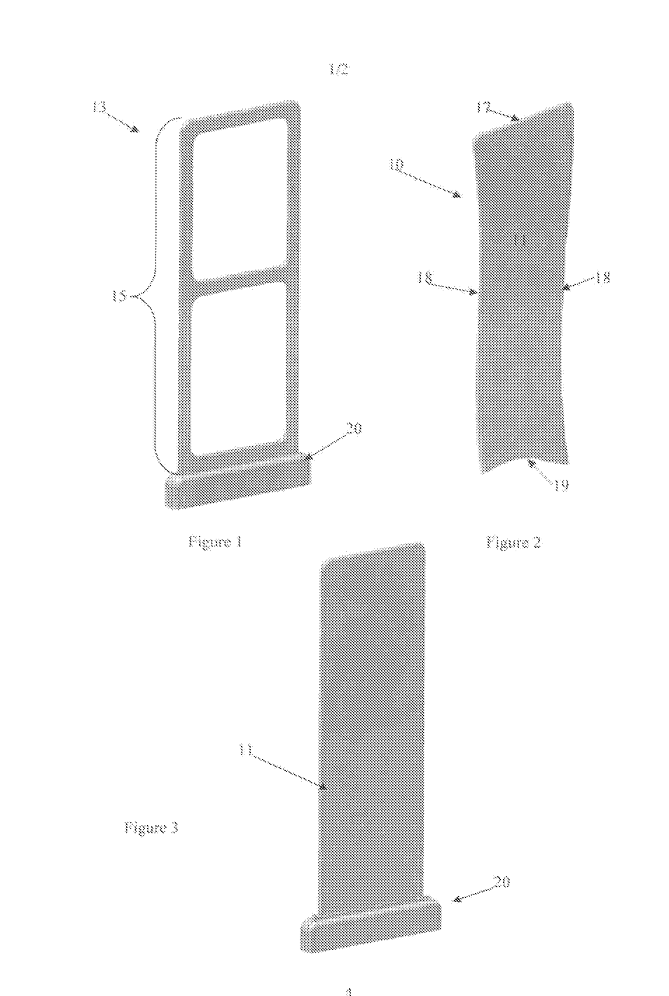

The media sock 10 illustrated in FIGS. 2,3 and 5 is a full sock having a pair of display surfaces and is closed at the upper and side edges with an open bottom.

The media sock, particularly when provided as a full sock is preferably at least partially resilient although, the media sock may be provided with one or more resilient portions.

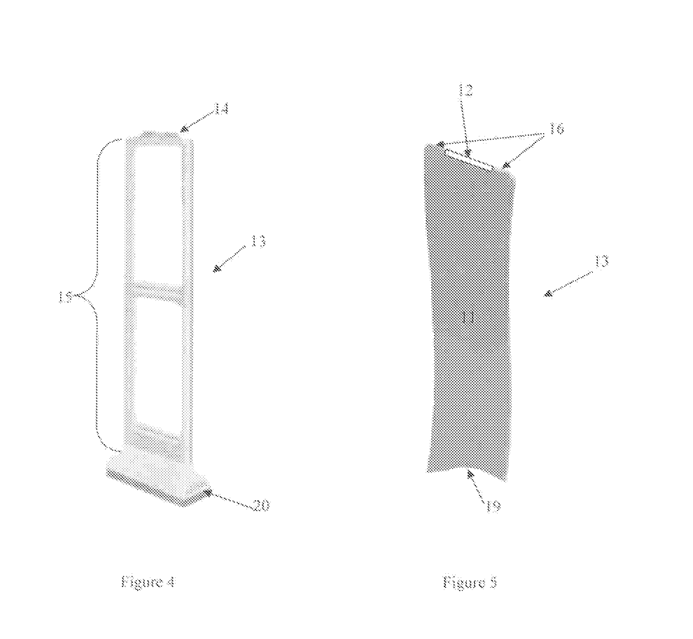

The media sock illustrated in FIG. 5 differs from that illustrated in FIGS. 2 and 3 in that it is provided with an opening 12 at an upper end. Some transmitters and/or receivers 13, such as that illustrated in FIG. 4, have one or more lights 14 at the top of the frame 15. Opening 12 is sized and located to allow the lights 14 to protrude through the media sock 10 but maintaining a shoulder portion 16 in order to prevent the media sock 10 slipping downward over the transmitter and/or receiver 13.

Typically, the sock including display surfaces 11 is fabric.

The indicia to be displayed may include one or more colours only (as illustrated) but will normally include printing or other advertising material designed to convey a particular message to viewers. Sublimation printing onto a fabric display surface is particularly preferred.

A full sock is typically formed from one or more pieces of fabric which are attached together along the top edge 17 and side edges 18 with an open bottom 19.

A full sock is provided with means for securing the sock 10 relative to the mounting portion or frame 15. In a simple form, this may include gathering at the lower end of the sock adjacent to the open bottom or alternatively and more preferred, resilient or elastic means provided adjacent the open bottom of the sock 10.

The media sock 10 illustrated is shaped and shaped to correspond with part of a transmitter and/or receiver 13. The media sock 10 is also sized to be taut when mounted on the frame 15 of the transmitter and/or receiver 13 in order to prevent creasing and the like which may obscure the indicia. Typically, the sock 10 is slightly resilient and must be expanded or deformed to an enlarged size approximately the size and shape of the mounting portion during mounting the media sock 10 and the resilient nature of the sock will then hold the sock onto the frame 15.

The media sock 10 includes a mounting assembly in order to mount the media sock 10 relative to a mounting portion. The mounting assembly may take any form and in its simplest form as illustrated, the mounting assembly is at least part of the sock itself. The preferred resilient nature of at least a part of the full sock then retains the full sock relative to the mounting portion.

A lower resilient portion may be provided in addition to or instead of providing a resilient sock, at or adjacent the open bottom 19. In this embodiment, a lower periphery of the sock may be size adjustable and slightly resilient to hold the sock relative to the frame 15.

In an alternative embodiment illustrated , the invention resides in a media sock display system including a mounting portion 13 including a frame projection 15 defining a shape for display and a media sock 10 including at least one display surface carrying indicia to be displayed and a mounting means to mount the media sock relative to the mounting assembly, wherein the at least one display surface is at least partially transparent to the non-visible portion of the electromagnetic spectrum but visually opaque.

The transmitter and/or receiver is generally a rectangular, upstanding object which are located on either side of a doorway. They typically include an enlarged foot 20 with an upstanding, generally rectangular frame 15. Whilst the particular form of transmitter and/or receiver may differ slightly between different security systems (which include RFID, electromagnetic and new acousto-magnetic systems), the mounting portion is generally similar in overall shape from all three systems.

As illustrated in FIG. 3, the media sock 10 covers the frame 15 of the transmitter and/or receiver 13 and extends downwardly to adjacent the foot 20. Preferably, the attachment mechanism (normally an elasticised periphery of the lower opening) is located adjacent or even abutting the foot 20. In this way, the transmitter and/or receiver will be covered and advertising can be displayed on the media sock 10.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A media sock including at least one display surface carrying indicia to be displayed and a mounting means to mount the media sock relative to a mounting assembly, wherein the at least one display surface is at least partially transparent to the non-visible portion of the electromagnetic spectrum but visually opaque.

2. A media sock as claimed in claim 1 wherein the indicia to be displayed includes advertising printed onto at least one display surface.

3. A media sock display system including a mounting assembly including a projection defining a shape for display and at least one media sock including at least one display surface carrying indicia to be displayed and a mounting means to mount the media sock relative to the mounting assembly, wherein the at least one display surface is at least partially transparent to the non-visible portion of the electromagnetic spectrum but visually opaque.

4. A media sock display system as claimed in claim 2 wherein the mounting assembly is a transmitter or receiver in an electronic article surveillance system.

5. A method of displaying media including the steps of providing a mounting portion including a projection defining a shape for display, providing a media sock including at least one display surface carrying indicia to be displayed wherein the at least one display surface is at least partially transparent to the non-visible portion of the electromagnetic spectrum but visually opaque and a mounting means to mount the media sock relative to the mounting assembly and mounting the media sock relative to the mounting assembly.
